(19) United States
(12) Patent Application Publication
(10) Pub. No.: US 2015/0198564 A1
(43) Pub. Date: Jul. 16, 2015

(54) ULTRASONIC DEVICE, ULTRASONIC TRANSDUCER DEVICE, ELECTRONIC DEVICE AND ULTRASONIC IMAGING DEVICE

(71) Applicant: SEIKO EPSON CORPORATION, Tokyo (JP)

(72) Inventor: Kogo ENDO, Chino (JP)

(21) Appl. No.: 14/587,129

(22) Filed: Dec. 31, 2014

(30) Foreign Application Priority Data
Jan. 14, 2014 (JP) 2014-003958

(51) Int. Cl. G01N 29/06

(52) U.S. Cl. CPC G01N 29/0654; G01N 2291/014

(57) ABSTRACT

An ultrasonic device which includes a substrate, a first ultrasonic transducer element and a second ultrasonic transducer element. The substrate is provided with a plurality of first openings and a second opening having a larger opening area than the first opening. The first ultrasonic transducer element is provided on a first vibration film which has a first area and closes the first openings for each first opening, and includes two electrodes with a piezoelectric body being interposed therebetween. The second ultrasonic transducer element is provided on a second vibration film which has a second area larger than the first area and closes the second opening, and includes two electrodes with a piezoelectric body being interposed therebetween. The first openings are disposed in an array form. The second opening is disposed between an outer periphery of the substrate and regions where the first opening parts are disposed in an array form.

### BACKGROUND

1. Technical Field

The present invention relates to an ultrasonic device and an ultrasonic transducer device, as well as a probe, an electronic device and an ultrasonic imaging device which utilize the same.

2. Related Art

An ultrasonic imaging device such as an ultrasonic diagnosis device is generally known as disclosed in WO-2005-120358. For the formation of ultrasonic images, an ultrasonic probe (probe) is pressed on an object to be detected. Contact pressure is measured during the pressing. cMUTs (electrostatic capacitive type) oscillator are utilized for the measurement of pressure. The applied pressure decreases a vacuum gap. Electrostatic capacity is measured according to the decrease in the vacuum gap with the cMUT oscillators.

WO-2005-120358 is an example of related art.

cMUT oscillators can be utilized for the formation of ultrasonic image and the measurement of pressure in combination. The cMUT oscillators are uniformly formed into the shame shape. The contact pressure acts on all of the cMUT oscillators, making it difficult to increase a measurement sensitivity of pressure while reducing degeneration of the ultrasonic receiving signal.

According to at least one aspect of the present invention, an ultrasonic device making it possible to measure a pressure with a high precision while the degeneration of the ultrasonic receiving signal is reduced, is provided.

### SUMMARY

(1) An aspect of the invention refers to an ultrasonic device comprising a substrate which is provided with a plurality of first openings and a second opening having a larger opening area than the first opening; a first ultrasonic transducer element provided, for each first opening, on a first vibration film which has a first area and closes the first openings, each of the first ultrasonic transducer elements including two electrodes with a piezoelectric body being interposed therebetween; and a second ultrasonic transducer element provided on a second vibration film which has a second area that is larger than the first area and closes the second opening, the second ultrasonic transducer element including two electrodes with a piezoelectric body being interposed therebetween, wherein the first openings are disposed in an array, and wherein the second opening is disposed between an outer periphery of the substrate and a region where the first opening parts are disposed in an array form.

The resonance frequency of the second vibration film varies depending on a strength of a pressure applied on the second vibration film. The pressure strength can be determined according to a variation in the resonance frequency. Herein, the second vibration film is larger than the first vibration film of the first ultrasonic transducer element for creation of ultrasonic image, making it possible to increase a pressure sensitivity at the second vibration film of the second ultrasonic transducer element. In this way, it is possible to increase the precision for the pressure measurement. The second ultrasonic transducer element has partially the same element structure as the first ultrasonic transducer element, making it possible to commonalize fabrication processes, at least partially, for the formations of the first ultrasonic transducer element and the second ultrasonic transducer element, in a process of fabricating the ultrasonic device. It is possible to suppress the increase in the fabrication steps as much as possible.

(2) It is possible to provide a plurality of the second openings, wherein the second ultrasonic transducer element are disposed individually at the plurality of second openings. When the pressure applied on each second ultrasonic transducer element is determined while the substrate is pressed on an object, it is possible to assume a posture of the ultrasonic device with respect to the object according to individual pressure strength. It is possible to provide an index for an adjustment of the posture of the ultrasonic device.

(3) The plurality of second openings can be disposed at three or more positions which include positions spaced apart from each other in a first direction and positions spaced apart from each other in a second direction intersecting with the first direction. When an equal pressure is detected at three positions, it is possible to establish a horizontal posture of the substrate with respect to the object.

(4) The second opening can have a circular shape in a plan view viewed from a thickness direction of the substrate. It is possible to increase the sensitivity of the second ultrasonic transducer element for such a pressure.

The ultrasonic device can be further provided with a backing material which is coupled to the substrate and forms a hermetically closed space together with the second vibration film within the second opening. It is possible to increase the sensitivity of the second ultrasonic transducer element for such a pressure.

(6) The ultrasonic device can be further provided with an electric conductor which is connected commonly to one of two electrodes of the first ultrasonic transducer element and one of two electrodes of the second ultrasonic transducer element. For the fabrication of the ultrasonic device, it is possible to form an electrode of the first transducer element, an electrode of the second transducer element and the electric conductor in a single step. It is possible to suppress the increase in the fabrication steps as much as possible.

(7) The first vibration film and the second vibration film can be formed of portions of a common continuous film. The surface of the first vibration film and the surface of the second vibration film are continuously connected to each other at the same level, making it possible that the pressure detected at the second vibration film reflects the posture of the first vibration film with a high precision.

(8) The ultrasonic device can be further provided with an acoustic lens which defines a surface having a recess between a region where the first openings are disposed in an array form and a region where the second opening is disposed, in a plan view in a thickness direction of the substrate. The ultrasonic vibration of the first vibration film transmits through the acoustic lens. Also, the ultrasonic vibration of the second vibration film transmits through the acoustic lens. The acoustic lens is divided acoustically by the recess into a region of the first opening and a region of the second opening, making it possible to prevent mutual influence between the first ultrasonic transducer element and the second ultrasonic transducer element through the acoustic lens.

(9) The ultrasonic device can be further provided with a first acoustic lens which is made of a first material and covers the first ultrasonic transducer element, and a second acoustic lens which is made of a second material different from the first material and covers the second ultrasonic transducer element. The ultrasonic vibration of the first vibration film transmits through the first acoustic lens. Also, the ultrasonic vibration of the second vibration film transmits through the second acoustic lens. It is possible to form acoustic lens with materials respectively suited to the vibrations of the first vibration film and the second vibration film. Besides, the first acoustic lens and the second acoustic lens are separated acoustically at the region of the first opening and the region of the second opening, making it possible to prevent mutual influence between the first ultrasonic transducer element and the second ultrasonic transducer element through the acoustic lens.

(10) In an ultrasonic transducer device including the ultrasonic device and a control unit, the control unit can be provided with a calculation unit which calculates a contact pressure on the basis of a variation in a resonance frequency of the second ultrasonic transducer element. In this configuration, the calculation unit determines the strength of the contact pressure according to the variation in the resonance frequency. It is possible to detect the resonance frequency with a high precision. As a result, it is possible to increase the detection sensitivity of the contact pressure.

(11) The control unit can be provided with a first driving control unit which outputs a driving signal for driving the first ultrasonic transducer element at a first frequency, and a second driving control unit which outputs a driving signal for driving the second ultrasonic transducer element at a second frequency that is lower than the first frequency. In this configuration, it is possible to increase the sensitivity of the contact pressure at the second ultrasonic transducer element.

(12) The second driving control unit can output the driving signal in a receiving period after the driving signal is output from the first driving control unit. It is possible to reduce the influence of the ultrasonic vibration of the second ultrasonic transducer element on the ultrasonic vibration of the first ultrasonic transducer element.

(13) The ultrasonic device or the ultrasonic transducer device can be assembled into a probe so as to be utilized. In this instance, the probe is provided with the ultrasonic device or the ultrasonic transducer device, and a housing supporting the ultrasonic device or the ultrasonic transducer device.

(14) The ultrasonic device or the ultrasonic transducer device can be assembled into an electronic device so as to be utilized. In this instance, the electronic device is provided with the ultrasonic device or the ultrasonic transducer device, and a processing unit which is connected to the ultrasonic device or the ultrasonic transducer device and processes an output of the ultrasonic device or the ultrasonic transducer device.

(15) The ultrasonic device or the ultrasonic transducer device can be assembled into an ultrasonic imaging device so as to be utilized. In this instance, the ultrasonic imaging device is provided with the ultrasonic device or the ultrasonic transducer device, a processing unit which is connected to the ultrasonic device or the ultrasonic transducer device and processes an output of the ultrasonic device or the ultrasonic transducer device so as to create an image, and a display device for displaying the image.

### BRIEF DESCRIPTION OF THE DRAWINGS

FIG. 1 is an external view schematically showing one specific example of an electronic device, namely an ultrasonic diagnosis device, according to one embodiment.

FIG. 2 is an expanded front view of an ultrasonic probe.

FIG. 3 is an expanded plan view of an ultrasonic device according to a first embodiment.

FIG. 4 is an expanded plan view of a second ultrasonic transducer.

FIG. 5 is a vertical cross-sectional view taken along line A-A in FIG. 3.

FIG. 6 is a block diagram schematically showing a circuit configuration of an ultrasonic diagnosis device.

FIG. 7 is an expanded vertical cross-sectional view of the second ultrasonic transducer element, and a block diagram schematically showing a relevant circuit configuration.

FIG. 8 is a chart schematically showing operation timings of a first ultrasonic transducer element and a second ultrasonic transducer element.

FIG. 9 is a view schematically showing one specific example of an image displayed on a screen of a display panel.

FIG. 10 is a plan view schematically showing one specific example of a light emitting element attached to an ultrasonic probe.

FIG. 11 is an expanded plan view of the ultrasonic device according to a second embodiment.

FIG. 12 is an expanded plan view of the ultrasonic device according to a third embodiment.

FIG. 13 is a block diagram schematically showing a portion of a circuit configuration according to a modified example.

FIG. 14 is a plan view of the ultrasonic device schematically showing an arrangement of the second ultrasonic transducer element according to one specific example.

FIG. 15 is a plan view of the ultrasonic device schematically showing an arrangement of the second ultrasonic transducer element according to another specific example.

FIG. 16 is a plan view of the ultrasonic device schematically showing an arrangement of the second ultrasonic transducer element according to another specific example.

FIG. 17 is an expanded plan view of the ultrasonic device according to a fourth embodiment.

FIG. 18, which corresponds to FIG. 7, is an expanded vertical cross-sectional view of a second ultrasonic transducer element according to a fourth embodiment with a block diagram schematically showing a relevant circuit configuration.

### DESCRIPTION OF EXEMPLARY EMBODIMENTS

The following describes an embodiment of the invention with reference to the attached drawings. The embodiments explained below are not intended to limit improperly the contents of the present invention described in claims. None of the structural details explained in the embodiments are absolutely necessary for the solution of the present invention.

(1) Overall Configuration of an Ultrasonic Diagnosis Device

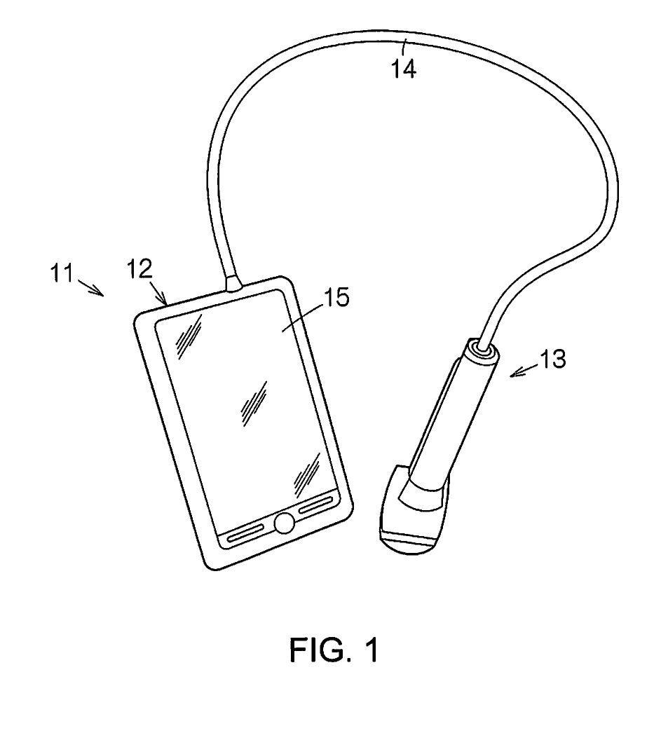

FIG. 1 schematically shows one specific example of a configuration of an electronic device, namely an ultrasonic diagnosis device (ultrasonic imaging device) 11, according to one embodiment of the present invention. The ultrasonic diagnosis device 11 is provided with a device terminal 12 and an ultrasonic probe (probe) 13. The device terminal 12 and the ultrasonic probe 13 are connected to each other via a cable 14. Electric signals are transmitted through the cable 14 between the device terminal 12 and the ultrasonic probe 13. A display panel (displaying device) 15 is assembled into the device terminal 12. A screen of the display panel 15 is exposed at a surface of the device terminal 12. In the device terminal 12, an image is created on the basis of ultrasonic waves detected with the ultrasonic probe 13, as described below. An imaged detection result is displayed on the screen of the display panel 15.

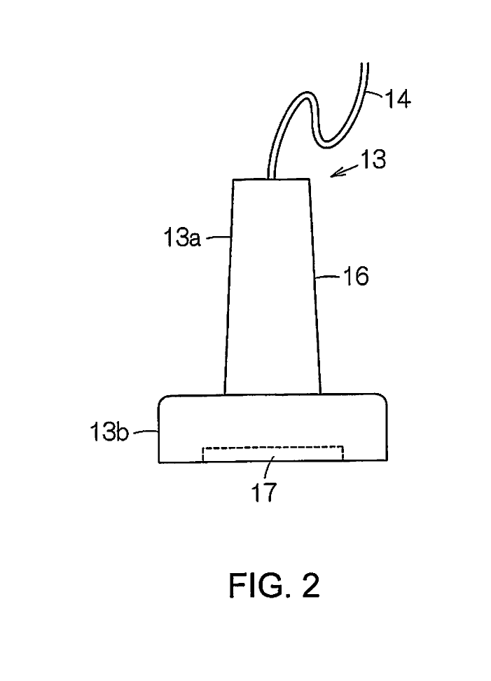

As shown in FIG. 2, the ultrasonic probe 13 has a housing 16. An ultrasonic device 17 is accommodated within the housing 16. A surface of the ultrasonic device 17 may be exposed at a surface of the housing 16. The ultrasonic device 17 outputs the ultrasonic wave from its surface and receives a reflection wave of the ultrasonic wave. Moreover, the ultrasonic probe 13 may be provided with a probe head 13b detachably connected to a probe main body 13a. In this configuration, the ultrasonic device 17 can be assembled within the housing 16 of the probe head 13b.

(2) Configuration of the Ultrasonic Device According to a First Embodiment

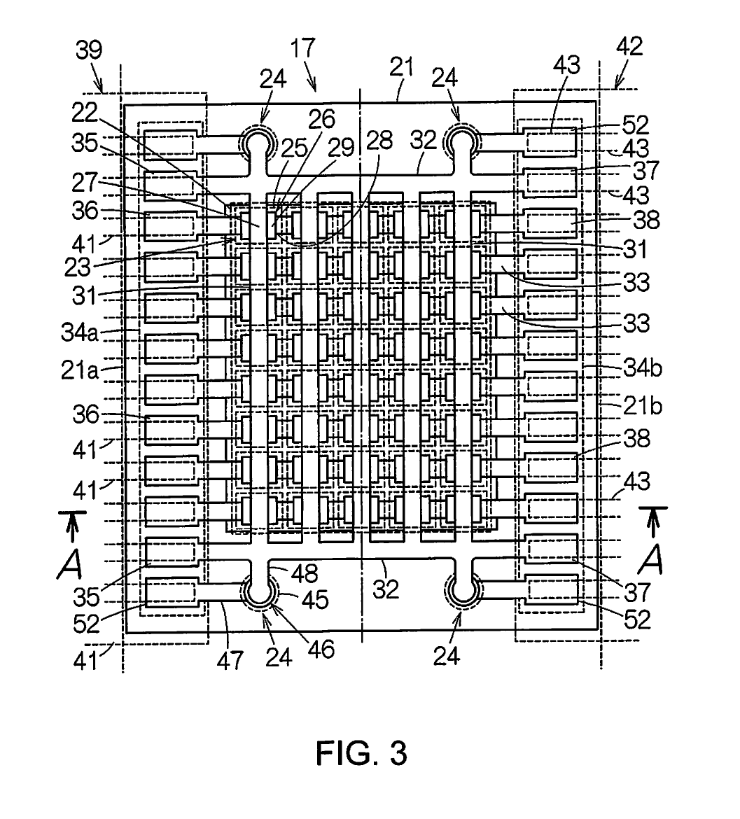

FIG. 3 schematically shows a plan view of the ultrasonic device 17. The ultrasonic device 17 is provided with a base 21. An element array 22 is provided on the base 21. The element array 22 is constituted by an arrangement of first ultrasound transducer elements (hereinafter referred to as “first elements”) 23. The arrangement is in form of a matrix with a plurality of lines and a plurality of rows. The arrangement may also be established as a zigzag arrangement. In such a zigzag arrangement, a group of first elements 23 in an even row can be displaced with respect to a group of first elements 23 in an odd row by one half of a line pitch. One of the number of the elements in an odd row and the number of the elements in an even row may be lower than the other by one. Second ultrasonic transducer elements (hereinafter referred to as “second elements”) 24 are disposed between the region of the element array 22 and an outer periphery of the base 21. In this configuration, a plurality of the second elements 24 are provided on the base 21.

Each first element 23 is provided with a vibration film (first vibration film) 25. In FIG. 3, the contour of each vibration film 25 is depicted as a dotted line in a plan view in a direction perpendicular to a film surface of the vibration film 25 (a plan view in a thickness direction of a substrate, which is simply referred to as “plan view” hereinafter). A piezoelectric element 26 is formed on the vibration film 25. The piezoelectric element 26 is composed of a top electrode (electrode) 27, a bottom electrode (electrode) 28 and a piezoelectric film (piezoelectric body) 29. The piezoelectric film 29 is interposed between the top electrode 27 and the bottom electrode 28 for each first element 23. The bottom electrode 28, the piezoelectric film 29 and the top electrode 27 are layered in this order. The supersonic device 17 is formed as a single ultrasonic transducer element chip.

A plurality of first electric conductors 31 is formed on the surface of the base 21. The first electric conductors 31 extend in parallel to each other in a line direction of the arrangement. One first electric conductor 31 is assigned to each line of first elements 23. One first electric conductor 31 is connected commonly to the piezoelectric body films 29 of the first elements 23 arranged in a line direction of the arrangement. The first electric conductor 31 forms the top electrode 27 for each of the first elements 23. Both ends of the first electric conductor 31 are connected to a pair of extension wires 32. The extension wires 32 extend in parallel to each other in a row direction of the arrangement. Accordingly, all of the first electric conductors 31 have the same length. In this way, the top electrodes 27 are connected commonly to the first elements 23 in the overall matrix. The first electric conductor 31 can be formed of iridium (Ir), for example. It is also possible to use another electrically conductive material as the first electric conductor 31.

A plurality of second electric conductors 33 is formed on the surface of the base 21. The second electric conductors 33 extend in parallel to each other in a row direction of the arrangement. One second electric conductor 33 is assigned to each row of the first elements 23. One second electric conductor 33 is disposed commonly to the piezoelectric films 29 of the first elements 23 arranged in the row direction of the arrangement. The second electric conductor 33 forms the bottom electrode 28 for each first element 23. For example, a laminate of titanium (Ti), iridium (Ir), platinum (Pt) and titanium (Ti) can be utilized for the second electric conductor 33. It is also possible to use another electrically conductive material as the second electric conductor 33.

It is possible to switch the electrical connection of the first elements 23 for each row. In response to the switch of the electrical connection, it is possible to achieve a linear scan and a sector scan. Since the first elements 23 in a single row can output ultrasonic waves simultaneously, the number of single lines, that is, the number of lines of the arrangement can be set depending on the output level of the ultrasonic wave. The number of lines can be set in a range of 10 to 15, for example. In the figures, some lines are not shown, and only five lines are shown. The number of rows of the arrangement can be set depending on the extent of a scan range. The number of rows can be set to 128 or 256, for example. In the figures, some rows are not shown, and only eight rows are shown. The functions of the top electrode 27 and the bottom electrode 28 can be reversed. That is, the bottom electrodes can be connected commonly to the first elements 23 of overall matrix, while the top electrodes can be connected commonly to the first elements 23 for each row of the arrangement.

The contour of the base 21 has a first side 21a and a second side 21b, which are defined by a pair of mutually parallel lines and face each other. A first terminal array 34a is disposed as a single line between the first side 21a and a contour of the element array 22. A line of a second terminal array 34b is disposed as a single line between the second side 21b and a contour of the element array 22. The first terminal array 34a can form one line parallel to the first side 21a. The second terminal array 34b can form one line parallel to the second side 21b. The first terminal array 34a is constituted by a pair of top electrode terminals 35 and a plurality of bottom electrode terminals 36. Similarly, the second terminal array 34b is constituted by a pair of top electrode terminals 37 and a plurality of bottom terminals 38. The two ends of each one extension wire 32 are respectively connected to the top electrode terminals 35, 37. The extension wire 32 and the top electrodes 35, 37 can be formed plane-symmetrically in relation to a perpendicular plane bisecting the element array 22. The two ends of one second electric conductor 33 are respectively connected to the bottom electrode terminals 36, 38. The second electric conductor 33 and the bottom electrodes 36, 38 can be formed plane-symmetrically in relation to a perpendicular plane bisecting the element array 22. Herein, the contour of the base 21 has a rectangular shape. The contour of the base 21 may also be square or trapezoidal. In the rectangular, square or trapezoidal form, the second elements 24 are assigned to the respective corners.

A first flexible printed circuit board (hereinafter referred to as “first circuit board”) 39 is connected to the base 21. The first circuit board 39 covers the first terminal array 34a. The first circuit board 39 is provided at its one end with electrically conductive lines, namely first signal lines 39 that respectively correspond to the top electrode terminals 35 and the bottom electrode terminals 36. The first signal lines 41 are respectively connected so as to face the top electrode terminals 35 and the bottom electrode terminals 36. Similarly, a second flexible printed circuit board (hereinafter referred to as “second circuit board”) 42 covers the base 21. The second circuit board 42 covers the second terminal array 34b. The second circuit board 42 is provided at its one end with electrically conductive lines, namely second signal lines 43 that respectively correspond to the top electrode terminals 37 and the bottom electrode terminals 38. The second signal lines 43 are respectively connected so as to face the top electrode terminals 37 and the bottom electrode terminals 38.

Each second element 24 is provided with a vibration film (second vibration film) 45. In FIG. 3, the contour of each vibration film 45 is depicted as a dotted line in a plan view. The area of the vibration film 45 (second area) is larger than the area of the vibration film 25 (first area). A piezoelectric element 46 is formed on the vibration film 45. A third electric conductor 47 and a fourth electric conductor 48 are connected to the piezoelectric element 46. The third electric conductor 47 and the fourth electric conductor 48 are formed on the surface of the base 21. The third electric conductor 47 is connected to a detection terminal 52. The detection terminals 52 are formed as components of the first terminal array 34a and the second terminal array 34b. Each detection terminal 52 is associated with the first signal line 41 of the first circuit board 39 or the second signal line 43 of the second circuit board 42. Each detection terminal 52 is arranged to face the corresponding first signal line 41 or the second signal line 43 and connected to the same individually. For example, a laminate of titanium (Ti), iridium (Ir), platinum (Pt) and titanium (Ti) can be utilized for the third electric conductor 47. It is also possible to use another electrically conductive material as the third electric conductor 47. The fourth electric conductor 48 is connected to the extension wire 32. The fourth electric conductor 48, the extension wire 32, the first electric conductor 31 and the top electrode are formed as a continuous film.

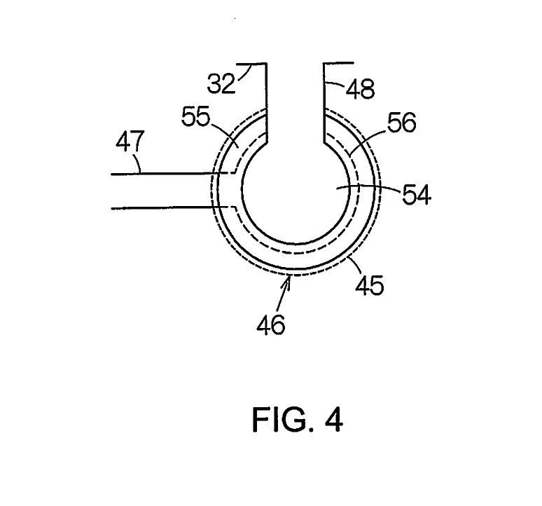

As shown in FIG. 4, the piezoelectric element 46 is formed of the top electrode (electrode) 54, the piezoelectric film (piezoelectric body) 55 and the bottom electrode (electrode) 56. As described below, the piezoelectric film 55 is interposed between the top electrode 54 and the bottom electrode 56 for each second element 24. The bottom electrode 56, the piezoelectric body film 55 and the top electrode 54 are layered in this order. Each third electric conductor 47 is connected to the corresponding bottom electrode 56. Each fourth electric conductor 48 is connected to the corresponding top electrode 54.

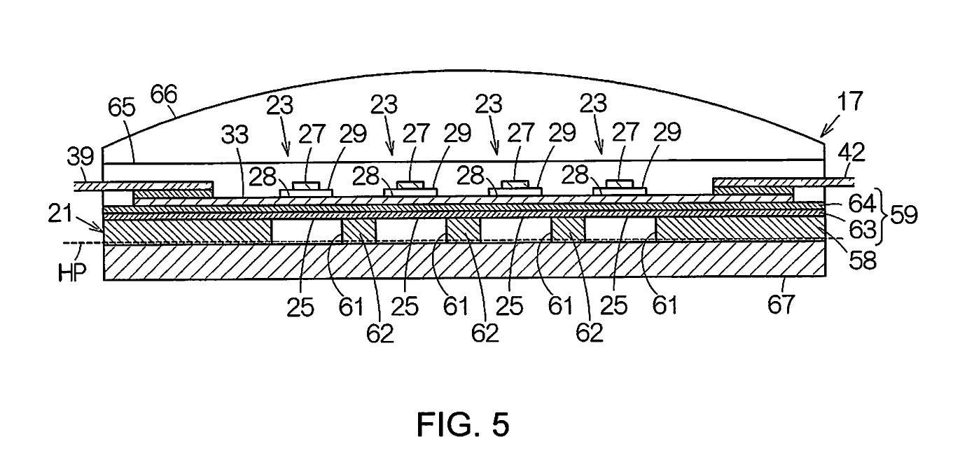

As shown in FIG. 5, the base 21 is provided with a substrate 58 and a flexible film (continuous film) 59. The flexible film 59 is formed over the entire surface of the substrate 58. The base plate 58 is provided with a first opening 61 for each first element 23. The first openings 61 are disposed in array form in relation to the substrate 58. A contour of a region in which the first openings 61 are disposed corresponds to a contour of the element array 22. A partitioning wall 62 is disposed between every two adjacent first openings 61. A wall thickness of the partitioning wall 62 corresponds to an interval between the first openings 61. The partitioning wall 62 defines two wall surfaces within planes which extend in parallel to each other. The wall thickness corresponds to a distance between the two wall surfaces. That is, the wall thickness can be defined by a length of a normal line which is orthogonal to the wall surfaces and interposed between the wall surfaces. The substrate 58 is formed of a silicon substrate, for example.

The flexible film 59 is made of a silicon oxide (SiO₂) layer 63 layered on a surface of the substrate 58 and a zirconium oxide (ZrO₂) layer 64 layered on a surface of the silicon oxide layer 63. The flexible film 59 is in contact with the first openings 61. In this configuration, a portion of the flexible film 59 forms the vibration film 25, in correspondence with the contour of the first opening 61. The vibration film 25 is that portion of the flexible film 59 that is exposed through the opening 61, and that is capable of vibrating in the thickness direction of the substrate 58. The flexible film 59 closes the first openings 61. The film thickness of the silicon oxide layer 63 may be set in accordance with the resonance frequency. The silicon oxide layer 63 can be formed by heat oxidation of a silicon substrate. The zirconium oxide layer 64 can be uniformly formed on the surface of the silicon oxide layer 63 by sputtering and the like, for example.

The bottom electrode 28, the piezoelectric body film 29 and the top electrode 27 are layered in this order on a surface of the vibration film 25. The piezoelectric film 29 can be made of lead zirconate titanate (PZT), for example. It is also possible to use another piezoelectric material as the piezoelectric film 29. Herein, the piezoelectric film 29 covers the second electric conductor 33 completely under the first electric conductor 31. With the function of the piezoelectric film 29, it is possible to prevent short-circuits between the first electric conductor 31 and the second electric conductor 33.

An acoustic matching layer 65 is layered on the surface of the base 21. The acoustic matching layer 65 covers the entire surface of the base 21, for example. As a result, the element array 22, the first and second terminal arrays 34a, 34b, and the first and second circuit boards 39, 42 are covered with the acoustic matching layer 65. For example, a silicone resin film can be used for the acoustic matching layer 65. The acoustic matching layer 65 protects the structure of the element array 22, an adhesion between the first terminal array 34a and the first circuit board 39, and an adhesion between the second terminal array 34b and the second circuit board 42.

An acoustic lens 66 is layered on the acoustic matching layer 65. The acoustic lens 66 is adhered intimately to a surface of the acoustic matching layer 65. The exterior surface of the acoustic lens 66 is formed into a partially cylindrical surface. The partially cylindrical surface has an apex line that is parallel to the first electric conductors 31. A curvature of the partially cylindrical surface is set in accordance with a focus position of the ultrasonic wave transmitted from the row of first elements 23 connected to one of the second electric conductors 33. The acoustic lens 66 can be made of a silicone resin, for example.

A backing plate (backing material) 67 is attached on the rear surface of the base 21. The rear surface of the base 21 is superimposed on a surface of the backing plate 67. The backing plate 67 closes the first openings 61 in the rear surface of the ultrasonic device 17. The backing plate 67 is provided with a rigid base material. Herein, the partitioning walls 62 are adhered to the backing plate 67. The backing plate 67 is adhered at at least one adhesion region to each partitioning wall 62. An adhesive can be used for the adhesion.

(3) Circuit Configuration in the Ultrasonic Diagnosis Device

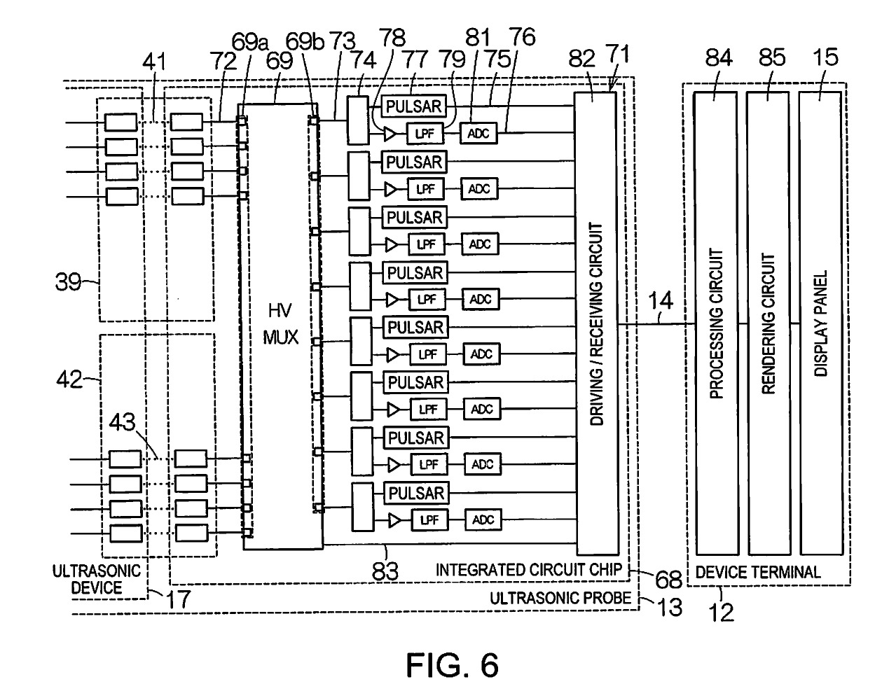

As shown in FIG. 6, the ultrasonic diagnosis device 11 is provided with an integrated circuit chip 68 electrically connected to the ultrasonic device 17. The integrated circuit chip 68 is provided with a multiplexer 69 and a transmission circuit 71. The multiplexer 69 is provided with a port group 69a on a side of the ultrasonic device 17 and a port group 69b on a side of the transmitting circuit 71. The first signal line 41 and the second signal line 43 are connected via wires 72 to the port group 69a on the side of the ultrasonic device 17. In this configuration, the port group 69a is connected to the element array 22. Herein, the port group 69b on the side of the transmitting circuit 71 is connected to the predetermined number of signal lines 73 within the integrated circuit chip 68. The predetermined number corresponds to the number of rows in the first element 23 simultaneously output in scanning. The multiplexer 69 manages the mutual connection between the ports on the side of the cable 14 and the ports on the side of the ultrasonic device 17. The integrated circuit chip 68 and the ultrasonic device 17 constitute an ultrasonic transducer device according to an embodiment.

The transmission circuit 71 is provided with a predetermined number of switches 7. Each switch 74 is connected to a corresponding signal line 73. The transmission circuit 71 is provided with a transmitting path 75 and a receiving path 76 for each switch 74. The transmitting paths 75 and the receiving paths 76 are connected to the switches 74 in parallel. The switches 74 connect the transmitting paths 75 or the receiving paths 76 selectively to the multiplexer 69. A pulsar (first driving control unit) 77 is provided in each of the transmitting paths 75. The pulsar 77 outputs a pulse signal at a frequency corresponding to the resonance frequency of the vibration film 25. An amplifier 78, a low-pass filter (LPF) 79 and an analog-digital converter (ADC) 81 are provided in each receiving path 76. The output signals of the first elements 23 are amplified and converted into digital signals.

The integrated circuit chip 68 is provided with a driving/receiving circuit 82. The transmitting path 75 and the receiving path 76 are connected to the driving/receiving circuit 82. The driving/receiving circuit 82 receives a digital signal of an output signal in accordance with the form of scanning. The driving/receiving circuit 82 is connected to the multiplexer 69 with a controlling line 83. The multiplexer 69 manages the mutual connection on the basis of the control signal supplied from the driving/receiving circuit 82.

A processing circuit 84 is provided in the device terminal 12. The processing circuit 84 can be provided with a central processing unit (CPU) and a memory, for example. The overall operation of the ultrasonic diagnosis device 11 is controlled in accordance with the processing of the processing circuit 84. The processing circuit 84 controls the driving/receiving circuit 82 in accordance with an instruction input from a user. The processing circuit 84 creates an image according to an output signal of the first elements 23. The image is specified by rendering data.

A rendering circuit 85 is assembled into the device terminal 12. The rendering circuit 85 is connected to the processing circuit 84. The display panel 15 is connected to the rendering circuit 85. The rendering circuit 85 generates a driving signal according to rendering data generated in the processing circuit 84. The driving signal is transmitted to the display panel 15. As a result, an image is displayed on the display panel 15.

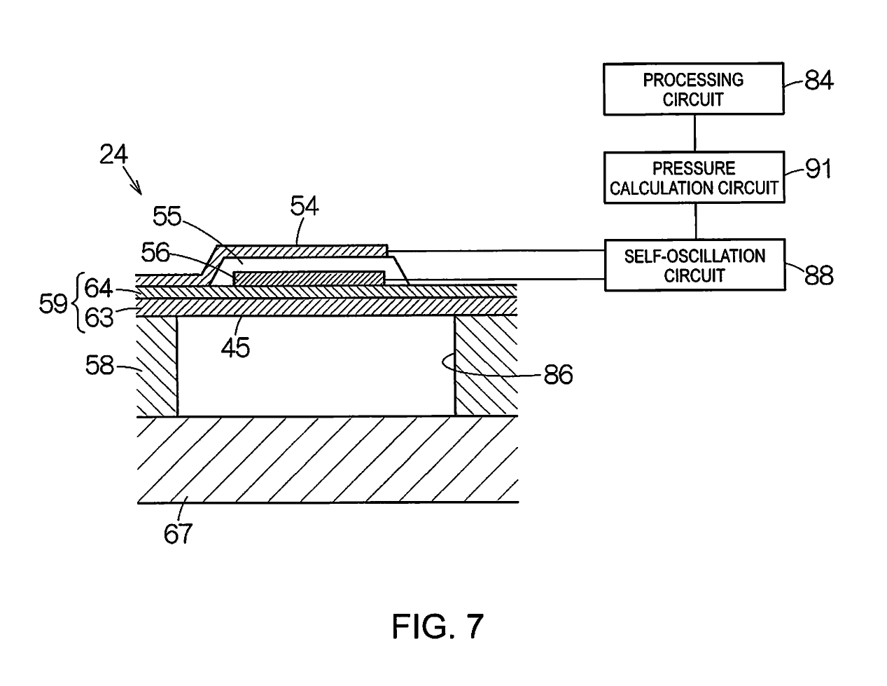

As shown in FIG. 7, a second opening 86 is formed in the substrate 58 for each second element 24. The flexible film 59 is in contact with the second opening 86. In this configuration, a portion of the flexible film 59 forms a vibration film 45, in correspondence with the contour of the second opening 86. The vibration film 45 is that portion of the flexible film 59 that is exposed through the second opening 86, and that is capable of vibrating in the thickness direction of the substrate 58. The vibration film 45 closes the second openings 86. Herein, the space of the second opening 86 is hermetically closed with the vibration film 45 and the backing plate 67.

The bottom electrode 56, the piezoelectric film 55 and the top electrode 54 are layered in this order on the surface of the vibration film 45. A self-oscillation signal circuit (second driving control unit) 88 is connected to the bottom electrode 56 and the top electrode 54. The self-oscillation signal circuit 88 outputs a self-oscillation signal. In response to the supply of the self-oscillation signal, the vibration film 45 oscillates at a frequency corresponding to its eigenfrequency. The resonance of the vibration film 45 is established. The self-oscillation signal circuit 88 is formed on the integrated circuit chip 68. The bottom electrode 28, the second electric conductor 33, the bottom electrode terminals 36, 38, the bottom electrode 56, the fourth electric conductor 48 and the detection terminal 52 can be formed of solid films of uniform electrically conductive materials by means of photolithography. Also, the piezoelectric film 55 and the piezoelectric film 29 can be formed of solid films of uniform piezoelectric bodies by means of photolithography technique. Also, the top electrode 27, the first electric conductor 31, the extension wire 32, the top electrode terminals 35, 37, the top electrode 54 and the third electric conductor 47 can be formed of solid films of uniform electrically conductive materials by means of photolithography.

A pressure calculation circuit 91 is connected to the self-oscillation circuit 88. The pressure calculation circuit 91 determines a pressure according to the resonance of the vibration film 45. The pressure calculation circuit 91 determines the resonance frequency of the vibration film 45 for the determination of pressure. The pressure calculation circuit 91 can calculate a pressure value in accordance with the resonance frequency of the vibration film 45. The pressure calculation circuit 91 determines a correlation between the resonance frequency of the vibration film 45 and the pressure value in advance. Such a correlation can be specified in terms of a relation formula such as a numerical formula, or specified in look-up table form. The pressure calculation circuit 91 outputs a pressure value signal. The pressure value is specified by the pressure value signal. The pressure value signal is supplied to the processing circuit 84, for example. In this configuration, the pressure is measured for each second element 24. The pressure calculation circuit 91 can be formed on the integrated circuit chip 68.

(4) Operation of Ultrasonic Diagnosis Device

Next, the operation of the ultrasonic diagnosis device 11 will be briefly explained. For the creation of an ultrasonic image, the ultrasonic probe 13 is pressed on an object to be detected. An acoustic coupling material such as gel is interposed between an acoustic lens 66 and an object to be detected. The processing circuit 84 commands the transmission and reception of ultrasonic wave to the driving/receiving circuit 82. The driving/receiving circuit 82 supplies a control signal to each multiplexer 69, and supplies the driving signal to each pulsar 77. The pulsars 77 output a pulse signal according to the supply of driving signal. The multiplexer 69 connects the port group 69a to the port group 69b, in accordance with the command of the control signal. A pulse signal is supplied to the first element 23 for each row via the bottom electrode terminals 36, 38 and the top electrode terminals 35, 37 in accordance with the selection of the port. An electric field acts on the piezoelectric film 29 between the top electrode 27 and the bottom electrode 28 in each first element 23. The piezoelectric film 29 vibrates in response to ultrasonic waves. The vibration of the piezoelectric film 29 is transmitted to the vibration film 25. As a result, a desired ultrasonic beam is transmitted towards on an object (for example, the interior of a human body).

After the transmission of ultrasonic waves, the switch 74 is arranged to perform switching. The multiplexer 69 maintains the connection of the ports. The switch 74 establishes the connection between the receiving path 76 and the signal line 73 instead of the connection between the transmission path 75 and the signal line 73. The reflected waves of ultrasonic waves vibrate the vibration films 25. As a result, an output signal is output from the first element 23. The piezoelectric film 29 generates an electric potential in response to its deformation between the top electrode 27 and the bottom electrode 28. The output signal is extracted at the top electrode 27 and the bottom electrode 28. The output signal is converted into a digital signal to be sent to the driving/receiving circuit 82.

The ultrasonic wave is repetitively transmitted and received. For the repetition, the multiplexer 69 alters the connection of ports. As a result, it is possible to achieve a linear scan and a sector scan. After completion of the scan, the processing circuit 84 creates an image on the basis of a digital output signal. The created image is displayed on a screen of the display panel 15.

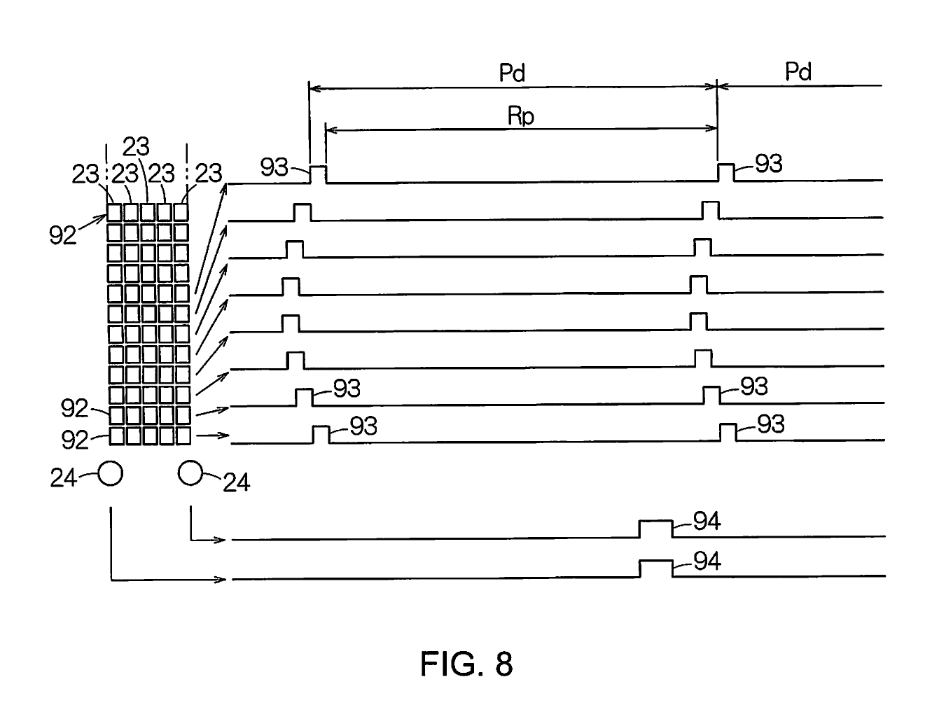

As shown in FIG. 8, pulse signals 93 of the pulsar 77 are transmitted at predetermined periods Pd. The first element 23 performs ultrasonic vibration simultaneously in each row 92. The supply of the pulse signal 93 can be slightly varied for each row 92 so as to be utilized for formation of a focus point. It is possible to assure a receiving period Rp according to switching of the switch 74 after the transmission of the pulse signal 93. The vibration film 25 vibrates in response to reflected waves of ultrasonic waves. A self-oscillation signal 94 is supplied from the self-oscillation circuit 88 to each second element 24 prior to termination of the receiving period Rp. In this configuration, the acoustic lens 66 is pressed on an object to be detected, increasing the resonance frequency of the vibration film 45. The frequency of the self-oscillation signal increases. The pressure calculation circuit 91 determines a pressure value of a contact pressure according to the determined resonance frequency. In this way, it is possible to measure the contact pressure for each second element 24.

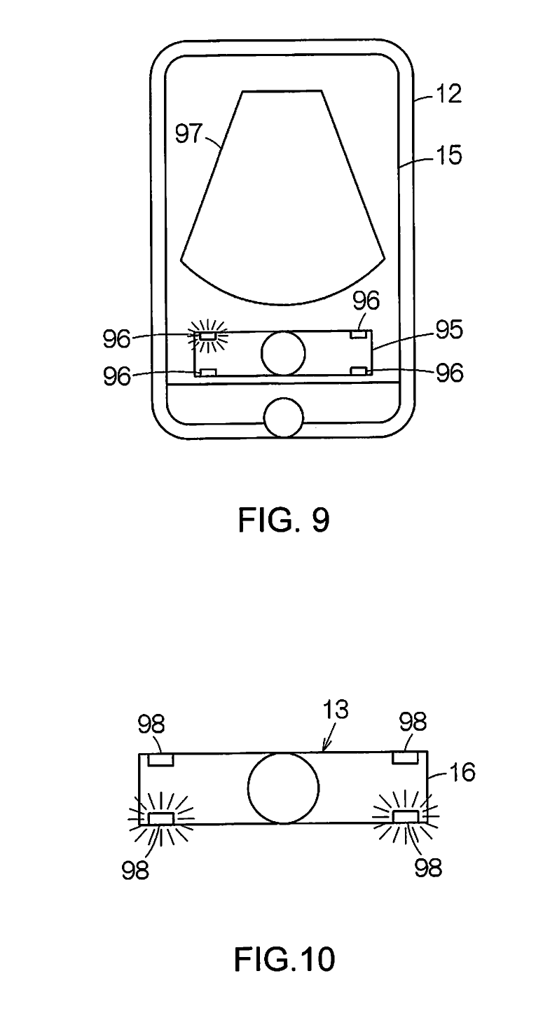

The processing circuit 84 receives a pressure value signal. For example, when an equal pressure is detected at four second elements 24, the processing circuit 84 recognizes a straight posture of the ultrasonic probe 13. It is possible to photograph an ultrasonic image in a cross-section that is perpendicular to a surface of an object to be detected. Besides, the processing circuit 84 supports a posture control of the ultrasonic probe 13 on the basis of the pressure value signal. For example, as shown in FIG. 9, a planar image 95 of the ultrasonic probe 13 is displayed on the screen of the display panel 15. Point images 96 are disposed in the planar image 95, in association with each second element 24. When a lower pressure is detected at a certain second element 24 than those of other second elements 24, the processing circuit 84 increases the brightness at the point image 96 corresponding to the specific second element 24 as shown in FIG. 9. An operator of the ultrasonic diagnosis device 11 can increase a pressing force at a corresponding position in accordance with the lighting of the point image 96. In this way, the operator can assure the straight posture of the ultrasonic probe 13 with the aid of the lighting of the point image 96. The processing circuit 84 can terminate the lighting of the point image 96 after confirmation of a balance of the detected pressure values. The processing circuit 84 may be arranged to measure the pressure value of the second element 24 prior to the formation of ultrasonic image. In this instance, the processing circuit 84 may be arranged to display the ultrasonic image 97 on the screen of the display panel 15 after confirmation of the straight posture of the ultrasonic probe 13. When the ultrasonic image 97 is not displayed prior to the confirmation of the straight posture, it is possible for the operator to confirm the straight posture of the ultrasonic probe 13 in accordance with the presence of the ultrasonic image 97.

A light emitter such as LED (light emitting element) may be utilized instead of such an image display. As shown in FIG. 10, it is possible to attach an LED 98, for example, to the housing 16 of the ultrasonic probe 13 at a position corresponding to the second element 24. Also, the processing circuit 84 is arranged to light the corresponding LED 98 when a lower pressure is detected at a specific second element 24. The operator can assure the straight posture of the ultrasonic probe 13 with the aid of the lighting of the LED 98.

The resonance frequency of the vibration film 45 varies depending on the strength of the pressure acting on the vibration film 45 of the second element 24. The pressure strength is determined according to the variation in the resonance frequency. In this configuration, as the vibration film 45 is larger than the vibration film 25 of the first element 32 utilized for creating ultrasonic image, the vibration film 45 of the second element 24 has a larger pressure sensitivity. In this way, it is possible to increase the precision for the measurement of pressure. The second element 24 has an element structure similar to that of the first element 23, making it possible to form the first element 23 and the second element 24 in a common formation process for the fabrication of the ultrasonic device 17. It is possible to prevent the increase in the fabrication steps.

The second elements 24 are disposed individually to the plurality of second openings 86 in the ultrasonic device 17. When the pressure acting on each second element 24 is determined while the ultrasonic device 17 is pressed on an object to be detected, it is possible to assume the posture of the ultrasonic device 17 with respect to the object to be detected according to each pressure strength. It is possible to provide an index for an adjustment of the posture of the ultrasonic device 17. In particular, the second openings 86 are disposed at three or more positions, which include positions spaced apart from each other with the region of the element array 22 interposed therebetween in a first direction as well as positions spaced apart from each other with the region of the element array 22 interposed therebetween in a second direction intersecting with the first direction.

The second opening 86 is formed into circular shape in a plan view viewed from the thickness direction of the substrate 58. In this configuration, it is possible to increase the pressure sensitivity of the second element 24. Also, the backing plate 67 forms a hermetically closed space together with the vibration film 45 within the second opening 86. In this configuration, it is possible to increase the pressure sensitivity of the second element 24.

In the ultrasonic device 17, a fourth electric conductor 48 is connected commonly to the top electrode 27 of the first element 23 and the top electrode 54 of the second element 24. For the fabrication of the ultrasonic device 17, the top electrode 27 of the first element 23, the top electrode 54 of the second element 24 and electric conductors 31, 48 can be formed in a single step. It is possible to suppress the increase in the fabrication steps as much as possible.

As described above, the vibration film 25 and the vibration film 45 are formed of portions of a common continuous film. The surface of the vibration film 25 and the surface of the vibration film 45 are continuously connected at the same level, enabling the pressure detected at the vibration film 45 to reflect the posture of the vibration film 25 with a high precision. With this arrangement, it is possible to detect the posture of the ultrasonic device 17 with a high precision.

The pressure calculation circuit 91 of the integrated circuit chip 68 calculates a contact pressure on the basis of the variation in the resonance frequency of the second element 24. The pressure calculation circuit 91 determines the strength of the contact pressure according to the variation in the resonance frequency. The resonance frequency can be detected with a high precision, thereby making it possible to increase the detection sensitivity of the contact pressure.

The pulsar 77 of the integrated circuit chip 68 outputs the driving signal for driving the first element 23 at the first frequency. The self-oscillation circuit 88 of the integrated circuit chip 68 outputs a driving signal for driving the second element 24 at the second frequency smaller than the first frequency. With this arrangement, it is possible to increase the sensitivity of the contact pressure at the second element 24.

The self-oscillation circuit 88 outputs the driving signal in a receiving period after a driving signal is output from the pulsar 77. It is possible to minimize the influence on the ultrasonic vibration of the second element 24 resulting from the ultrasonic vibration of the first element 23.

(5) Configuration of the Ultrasonic Device According to a Second Embodiment

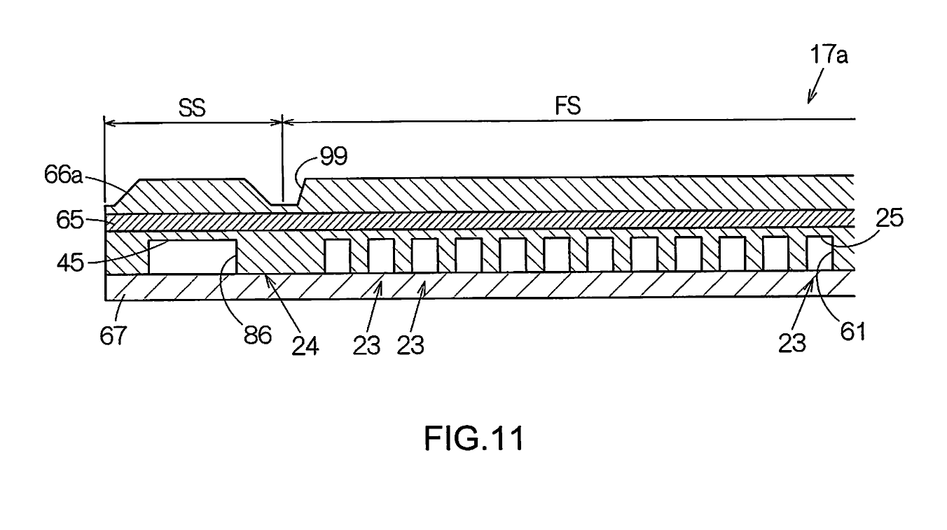

FIG. 11 systematically shows a partial perpendicular cross-sectional view of the ultrasonic device 17a according to a second embodiment. In the ultrasonic device 17a, the acoustic lens 66a defines a surface having a recess 99. The recess 99 is disposed between a region FS of the element array 22 and a region SS where the second opening 86 is disposed, in a plan view. The recess 99 partitions the two regions FS, SS, and may be formed into linear recess, V-shaped recess, U-shaped recess or the like. For the detection of the contact pressure, the ultrasonic vibration of the vibration film 45 of the second element 24 transmits through the acoustic lens 66a. Also, the ultrasonic vibration of the vibration film 25 of the first element 23 transmits through the acoustic lens 66a. The acoustic lens 66a is acoustically divided into the region FS of the first opening 61 and the region SS of the second opening 86 by the recess 99, making it possible to prevent the mutual influence between the first element 23 and the second element 24 through the acoustic lens 66a. Other configurations are same as those of the ultrasonic device 17 according to the first embodiment.

(6) Configuration of the Ultrasonic Device According to a Third Embodiment

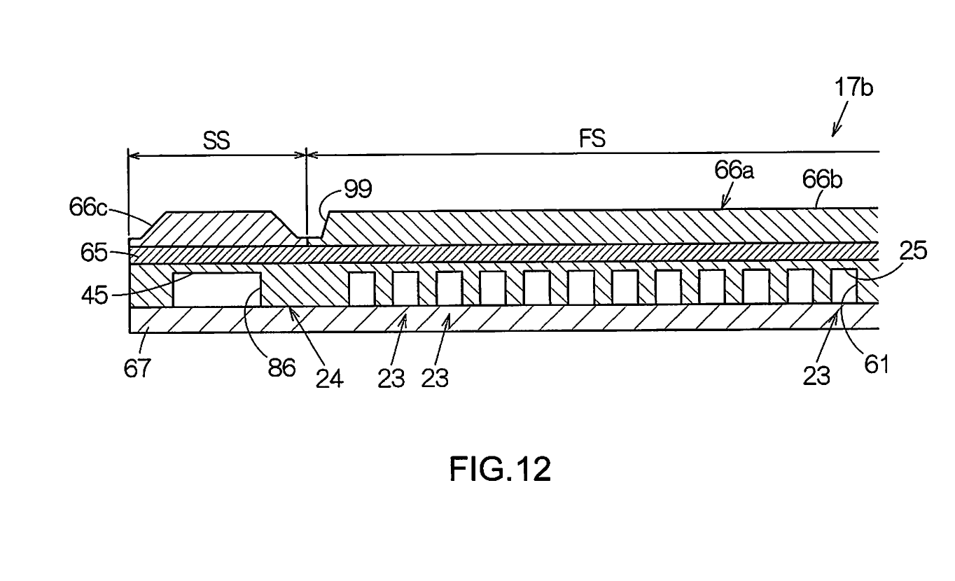

FIG. 12 systematically shows a partial perpendicular cross-sectional view of the ultrasonic device 17b according to a third embodiment. In the ultrasonic device 17b, the acoustic lens 66a is divided into a first acoustic lens 66b and a second acoustic lens 66c. The acoustic lens 66b is made of a first material. The first acoustic lens 66b covers the first elements 23 in the region FS of the element array 22, in a plan view. The second acoustic lens 66c is made of a second material different from the first material. The second acoustic lens 66c covers the second element 24 in the region SS of the second element 24. For the detection of contact pressure, the ultrasonic vibration of the vibration film 25 of the first element 23 transmits through the first acoustic lens 66b. The ultrasonic vibration of the vibration film 45 of the second element 24 transmits through the second acoustic lens 66c. In this configuration, the acoustic lenses 66b, 66c can be made of materials suitable for the vibrations of the vibration film 25 and the vibration film 45, respectively. In addition, when the first acoustic lens 66b and the second acoustic lens 66c are arranged to have different acoustic impedances, the first acoustic lens 66b can be acoustically separated from the second acoustic lens 66c between the region FS of the first elements 23 and the region SS of the second element 24, making it possible to prevent mutual influence between the first elements 23 and the second element 24 through the acoustic lens 66a. Other configurations are same as those of the ultrasonic device 17 according to the first embodiment.

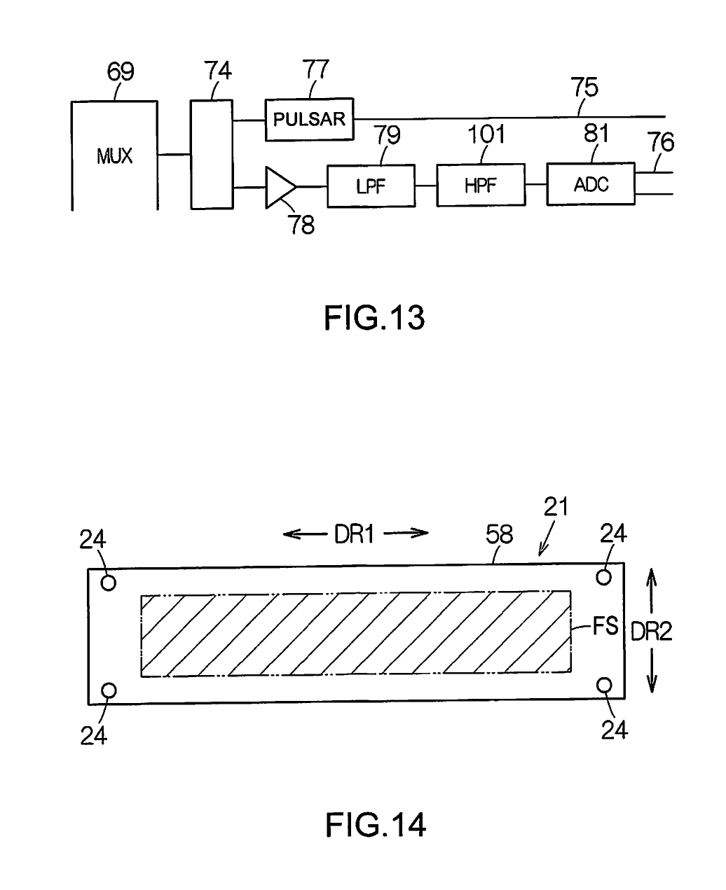

In other ultrasonic devices 17, 17a, 17b, the ultrasonic vibration of the second element 24 may be removed from the receiving signal of the first element 23 in signal processing. In this instance, as shown in FIG. 13, a high-pass filter (HPF) 101 is connected to the receiving path 76. The HPF 101 can remove signals having lower frequencies than the resonance frequency of the first element 23 from the receiving signals. With this arrangement, it is possible to remove the influence on the first element 24 from the first element 23.

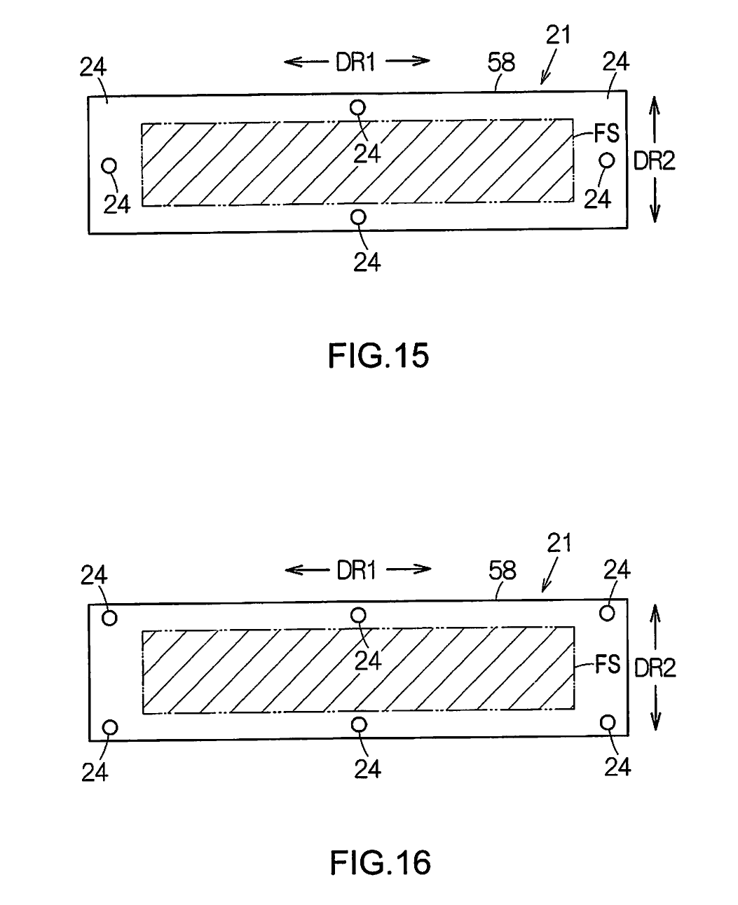

As shown in FIG. 14, the second elements 24 are disposed at three or more positions including positions spaced apart from each other in a first direction DR1 and positions spaced apart from each other in a second direction DR2 intersecting with the first direction DR1. When an equal pressure is detected at three portions, it is possible to assure the straight posture of the ultrasonic probe 13, a horizontal posture of the substrate 58 for an object to be detected. It is desired that the second elements 24 are disposed to be away from each other to the maximum extent in a region that the ultrasonic probe 13 always comes into contact with the object to be detected when pressed, outside of the region FS of the element array 22 in a plan view. As shown in FIG. 15, the second element 24 may be disposed at two pairs of portions with the region FS of the element array 22 interposed therebetween in the first direction DR1 and the second direction DR2. As shown in FIG. 16, the second element 24 may be added at an intermediate portion between the positions which are spaced apart from each other to the maximum extent.

(7) Configuration of the Ultrasonic Device According to a Fourth Embodiment

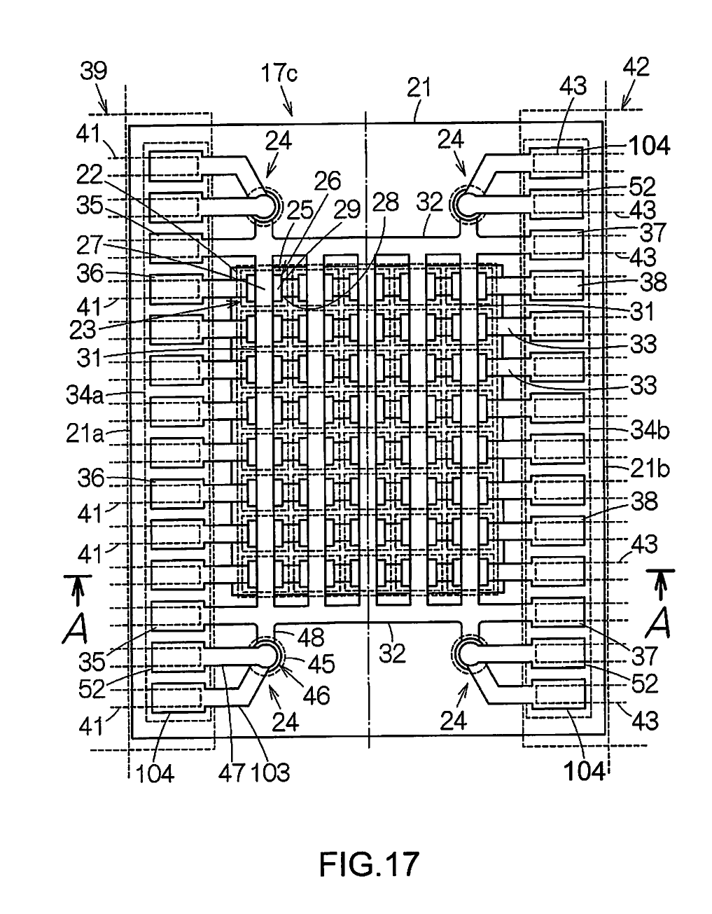

FIG. 17 systematically shows a configuration of the ultrasonic device 17c according to a fourth embodiment. In the ultrasonic device 17c, a fifth electric conductor 103 is connected to the piezoelectric element 46 of the second element 24, in addition to the third electric conductor 47 and the fourth electric conductor 48. The fifth electric conductor 103 is formed on the surface of the base 21. The fifth electric conductor 103 is connected to the driving terminal 104. The driving terminals 104 are formed as components of the first terminal array 34a and the second terminal array 34b. The driving terminal 104 are individually associated with the first signal line 41 of the first circuit board 39 or the second signal line 43 of the second circuit board 42. The driving terminals 104 are arranged to face the corresponding first signal line 41 or the second line 43 and joined to the same individually. For example, a laminate of titanium (Ti), iridium (Ir), platinum (Pt) and titanium (Ti) can be utilized for the fifth electric conductor 103. It is also possible to use another electrically conductive material as the fifth electric conductor 103.

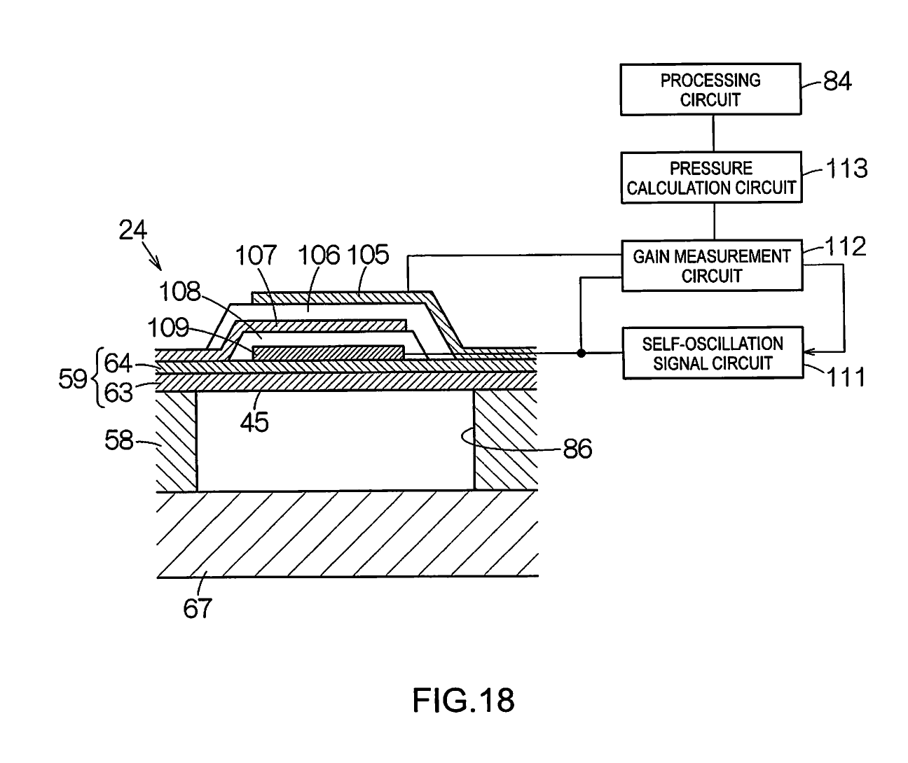

As shown in FIG. 18, the piezoelectric element 46 is composed of a top electrode (electrode) 105, a first piezoelectric film (piezoelectric body) 106, an intermediate electrode (electrode) 107, a second piezoelectric film (piezoelectric body) 108 and a bottom electrode (electrode) 109. The first piezoelectric film 106 is interposed between the top electrode 105 and the intermediate electrode 107. The second piezoelectric film 108 is interposed between the intermediate electrode 107 and the bottom electrode 109. These are layered in the order of the bottom electrode 109, the second piezoelectric film 108, the intermediate electrode 107, the first piezoelectric film 106 and the top electrode 105. The third electric conductors 47 are individually connected to the corresponding top electrodes 105. The fourth electric conductors 48 are individually connected to the corresponding intermediate electrodes 107. The fifth electric conductors 103 are individually connected to the corresponding bottom electrodes 109.

A self-oscillation signal circuit (second driving control unit) 111 is connected to the bottom electrode 109 and the intermediate electrode 107. The self-oscillation signal circuit 111 outputs a self-oscillation signal. In response to the supply of the self-oscillation signal, the vibration film 45 vibrates at a predetermined frequency. The self-oscillation signal circuit 111 is formed on the integrated circuit chip 68. The bottom electrode 28, the second electric conductor 33, the bottom electrode terminals 36, 38, the bottom electrode 109, the third electric conductor 47 and the detection terminal 52 can be formed of solid films of uniform electrically conductive materials by means of photolithography technique. Also, the second piezoelectric film 108 and the piezoelectric film 29 can be formed of solid films of uniform piezoelectric bodies by means of photolithography technique. Also, the top electrode 27, the first electric conductor 31, the extension wire 32, the top electrode terminals 35, 37, the intermediate electrode 107 and the fourth electric conductor 48 can be formed of solid films of uniform electrically conductive materials by means of photolithography technique.

A gain measurement circuit 112 is connected to the intermediate electrode 107 and the top electrode 105. The gain measurement circuit 112 measures a vibration gain of the vibration film 45. The gain measurement circuit 112 extracts the vibration gain during resonance. When the resonance is established at the vibration film 45, the vibration gain increases up to the maximum. The gain measurement circuit 112 supplies the control signal to the self-oscillation circuit 111. The control signal specifies the frequency of the self-oscillation signal. The gain measurement circuit 112 performs a feed-back control for the self-oscillation circuit 111, establishing the resonance of the vibration film 45. The gain measurement circuit 112 is formed on the integrated circuit chip 68.

A pressure calculation circuit 113 is connected to the gain measurement circuit 112. The pressure calculation circuit 113 identifies a pressure in accordance with the resonance of the vibration film 45. In the pressure calculation circuit 113, the pressure value can be calculated in accordance with the resonance frequency of the vibration film 45. In the pressure calculation circuit 113, it is possible to determine the relationship between the resonance frequency of the vibration film 45 and the pressure value in advance. Such relationship can be identified by a relation formula, or identified on the basis of look-up table or the like. The pressure calculation circuit 113 outputs a pressure value signal. The pressure value is identified on the basis of the pressure value signal. The pressure value signal is supplied to the processing circuit 84, for example. In this configuration, the pressure is measured for each second element 24. The pressure calculation circuit 113 is formed on the integrated circuit chip 68. Other configurations are same as those according to the above-mentioned embodiments.

When the acoustic lens 66 is pressed on an object to be detected, the resonance frequency of the vibration film 45 increases at the second element 24. The resonance frequency of the vibration film 45 comes to deviate from the frequency of the self-oscillation signal 94, decreasing the vibration gain of the vibration film 45. In response to the decrease in the vibration gain, the gain measurement circuit 112 supplies a control signal to the self-oscillation signal circuit 111. The control signal specifies higher frequency than ever. In this way, it is possible to increase the frequency of the self-oscillation signal 94. The maximum vibration gain is detected. The maximum vibration gain corresponds to a vibration gain during resonance. In this way, the resonance frequency is identified at the gain measurement circuit. The pressure calculation circuit determines the pressure value of the contact pressure in accordance with the identified resonance frequency. In this way, the contact pressure is measured for each second element 24.

Although some embodiments of the invention have been described above in detail, those skilled in the art will readily understand that various modifications may be made without substantially departing from the new items and the effects of the invention. Therefore, such modifications are entirely included within the scope of the invention. For example, any term described at least once together with a broader or synonymous different term in the specification or the drawing may be replaced by the different term at any place in the specification or the drawings. Besides, configurations and operations of the terminal device 12, the ultrasonic probe 13, the display panel 15, the integrated circuit chip 68 and so forth are not limited to those described in the present embodiment, but may be modified in various ways.

The entire disclosure of Japanese Patent Application No. 2014-003958 filed on Jan. 14, 2014 is expressly incorporated by reference herein.

What is claimed is:

1. A ultrasonic device comprising:
a substrate which is provided with a plurality of first openings and a second opening having a larger opening area than the first openings,
a first ultrasonic transducer element provided, for each first opening, on a first vibration film which has a first area and closes the first openings, each of the first ultrasonic transducer elements including two electrodes with a piezoelectric body being interposed therebetween, and
a second ultrasonic transducer element provided on a second vibration film which has a second area that is larger than the first area and closes the second opening, the second ultrasonic transducer element including two electrodes with a piezoelectric body being interposed therebetween,
wherein the first openings are disposed in an array, and wherein the second opening is disposed between an outer periphery of the substrate and a region where the first opening parts are disposed in an array form.

2. The ultrasonic device according to claim 1 comprising a plurality of the second openings, and the second ultrasonic transducer elements are disposed individually at the second openings.

3. The ultrasonic device according to claim 2, wherein the plurality of second openings are disposed at three or more positions which include positions spaced apart from each other in a first direction and positions spaced apart from each other in a second direction intersecting with the first direction.

4. The ultrasonic device according to claim 1, wherein the second opening has a circular shape in a plan view viewed from a thickness direction of the substrate.

5. The ultrasonic device according to claim 1 further comprising a backing material which is coupled to the substrate and forms a hermetically closed space together with the second vibration film within the second opening.

6. The ultrasonic device according to claim 1 further comprising an electric conductor which is connected commonly to one of two electrodes of the first ultrasonic transducer element and one of two electrodes of the second ultrasonic transducer element.

7. The ultrasonic device according to claim 1, wherein the first vibration film and the second vibration film are formed of portions of a common continuous film.

8. The ultrasonic device according to claim 1 further comprising an acoustic lens which defines a surface having a recess between a region where the first openings are disposed in an array form and a region where the second opening is disposed, in a plan view in a thickness direction of the substrate.

9. The ultrasonic device according to claim 1 further comprising a first acoustic lens which is made of a first material and covers the first ultrasonic transducer element and a second acoustic lens which is made of a second material different from the first material and covers the second ultrasonic transducer element.

10. An ultrasonic transducer device comprising the ultrasonic device according to claim 1 and a control unit, wherein the control unit is provided with a calculation unit which calculates a contact pressure on the basis of a variation in a resonance frequency of the second ultrasonic transducer element.

11. The ultrasonic transducer device according to claim 10, wherein the control unit is provided with a first driving control unit which outputs a driving signal for driving the first ultrasonic transducer element at a first frequency, and a second driving control unit which outputs a driving signal for driving the second ultrasonic transducer element at a second frequency that is lower than the first frequency.

12. The ultrasonic transducer device according to claim 11, wherein the second driving control unit outputs the driving signal in a receiving period after the driving signal is output from the first driving control unit.

13. A probe comprising the ultrasonic device or the ultrasonic transducer device according to claim 1, and a housing supporting the ultrasonic device or the ultrasonic transducer device.

14. An electronic device comprising the ultrasonic device or the ultrasonic transducer device according to claim 1, and a processing unit which is connected to the ultrasonic device or the ultrasonic transducer device and processes an output of the ultrasonic device or the ultrasonic transducer device.

15. An ultrasonic imaging device comprising the ultrasonic device or the ultrasonic transducer device according to claim 1, a processing unit which is connected to the ultrasonic device or the ultrasonic transducer device and processes an output of the ultrasonic device or the ultrasonic transducer device so as to create an image, and a display device for displaying the image.
